(19) United States
(12) Patent Application Publication
(10) Pub. No.: US 2019/0152089 A1
(43) Pub. Date: May 23, 2019

(54) ADJUSTABLE LOG JACK

(71) Applicant: BAC INDUSTRIES, INC., Miltona, MN (US)

(72) Inventors: Robert H. Lusty, Alexandria, MN (US); James D. Oberg, Eagle Bend, MN (US)

(21) Appl. No.: 15/817,837

(22) Filed: Nov. 20, 2017

(51) Int. Cl. B27B 17/00

(52) U.S. Cl. CPC B27B 17/0075

(57) ABSTRACT

A jack for elevating logs from the ground comprises an elongated pole as a handle lever, the pole having a steel collar surrounding its distal end and terminating in a steel spike. Welded to the collar along an upper surface is a serrated rib. Beneath it is a wheel assembly that serves as a fulcrum. Proximal of the collar is a clamp for fastening a T-shaped stand to the pole. An adjustment bar is welded to the collar and to the clamp, the adjustment bar having a plurality of longitudinally spaced apertures extending therethrough. An arcuate claw member with a tooth at its distal end has its opposite end fastened by a shoulder bolt as a pivot to the adjustment bar at a selected one of the aperture locations to accommodate logs of different circumferences.

### CROSS REFERENCE TO RELATED APPLICATIONS

None

### STATEMENT OF GOVERNMENT SPONSORSHIP

None

### BACKGROUND OF THE INVENTION

### I. Field of the Invention

This invention relates generally to a device for lifting logs, and particularly to a peavey or cant hook adapted to elevate a log from the ground to facilitate cutting thereof.

### II. Discussion of the Prior Art

Various tools are disclosed in the prior art that are commonly referred to as “log jacks”. Those involved with downing trees and cutting them up into logs using a chainsaw or the like are aware that if the chainsaw is even momentarily allowed to touch the ground, the chain is dulled to the point where re-sharpening is required before it can again be used to saw through a log. Also, by elevating a downed tree prior to cutting, trapping of the saw blade in the kerf is avoided.

A peavey is a tool used in the logging industry that generally comprises an elongated pole having a sharp point at one end along with a hook that is pivotally joined to the pole. The hook comprises an arcuate steel member having a pointed tooth at its free end. It is known in the art to add a protruding foot to the pole that acts as a fulcrum to convert the peavey to a lever of the first class to facilitate the lifting of one end of a cut tree trunk or a log a sufficient distance off from the ground, allowing it to be sawed without danger of the saw coming into contact with the ground.

It is also often desirable to be able to transport a cut log without having to manually grasp it and carry it to a somewhat remote location where other operations, such as splitting, may be taking place. A conventional peavey does not provide for ready transport.

In that the diameter of logs may vary, it is advantageous that the hook position be changeable along the length of the elongated pole so that the tooth on the hook will reach around and dig into the log at a location where the grip will not be lost as the log is being elevated by forcing the proximal end of the handle down onto the ground.

It is accordingly the purpose of the present invention to provide an improved log jack.

### SUMMARY OF THE INVENTION

The present invention provides a log jack for elevating logs off the ground to facilitate cutting by a chainsaw. It comprises an elongated handle having a proximal end and distal end. A steel collar is affixed to the distal end of the handle with the collar terminating in a pointed spike. Projecting out from the collar is a serrated rib to facilitate gripping of a log. Also secured to the collar and oriented 180° from the serrated rib is a bracket having a Y-shape where the stem of the Y is secured to the collar and the arms support an axel member at the ends thereof on which a pair of wheels are journaled for rotation. A stand member is affixed to the handle and longitudinally displaced in the proximal direction from the axel. An arcuate claw member is pivotally joined at one end to an adjustment bar that is affixed to the steel collar. The arcuate claw includes a log-engaging tooth at its free end. The adjustment bar includes a plurality of longitudinally-spaced apertures where any one of which is adapted to receive a pivot member used to pivotally join the arcuate claw member to the attachment bar.

The above-described configuration not only permits a log to be grasped and elevated by lever action, but also permits transport of a log, given the presence of the wheels appended to the handle.

### DESCRIPTION OF THE DRAWINGS

The foregoing features, objects and advantages of the invention will become apparent to those skilled in the art from the following detailed description of a preferred embodiment, especially when considered in conjunction of the accompanying drawings in which like numerals in the several views refer to corresponding parts.

FIG. 1 is a perspective view of a preferred embodiment; and

FIG. 2 is a front elevation thereof.

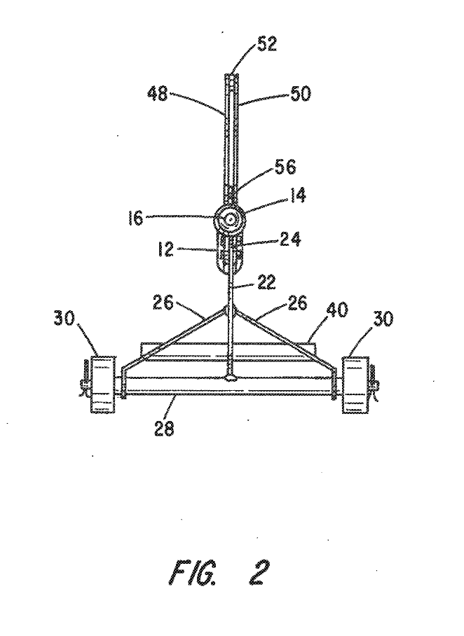

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

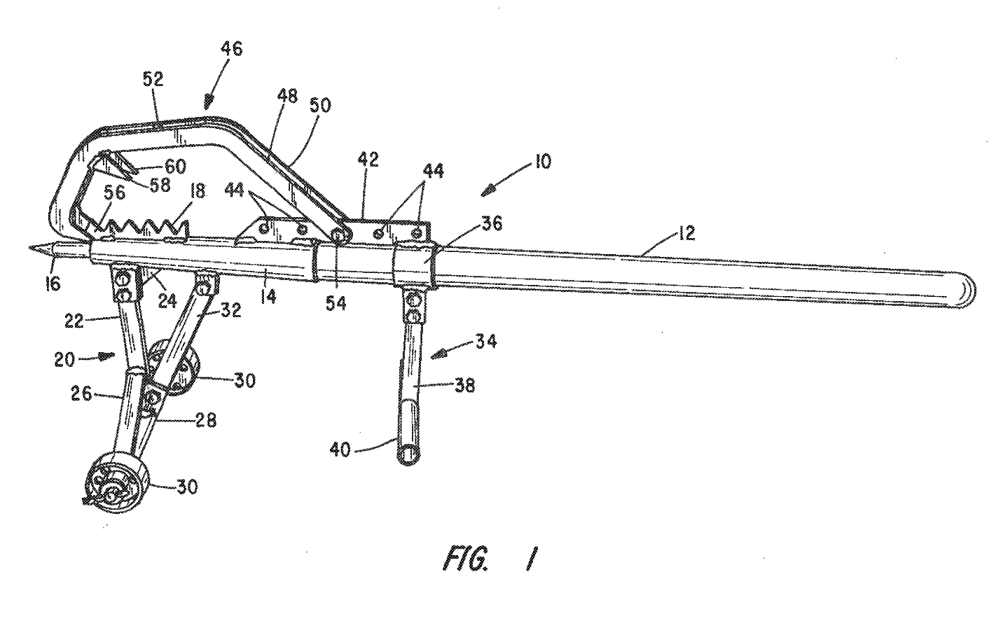

The log jack of the present invention is shown in FIG. 1 and is indicated generally by numeral 10. It is seen to include an elongated pole 12 as a handle which may be wooden or a suitable metal. Without limitation, the handle may be four to five feet in length and affixed to its distal end is a steel collar 14, preferably somewhat frusto-conical in shape and terminating in a pointed spike 16 at its distal end.

Projecting vertically upward from the collar 14 is a serrated rib 18 exhibiting a plurality of sharpened points adapted to dig into the bark of a log to be elevated. Also affixed to the collar 14 is a wheel assembly 20 comprising a Y-shaped bracket 22 having the stem of the Y bolted or otherwise affixed to a welded ear 24 that projects downward from the collar 14. The two arms of the Y, identified by numeral 26, support an axel 28 upon which a pair of wheels 30 are journaled for rotation. A brace 32 is affixed to and extends between the collar 14 and the axel 28.

Located a predetermined distance proximally along the length of the handle 12 is a stand assembly 34 that includes an annular clamp 36 surrounding the handle 12 and to which is attached an inverted T-shaped stand where the stem of the T 38 is bolted to the clamp 36 and the cross member 40 of the T is adapted to engage the ground to maintain the log jack elevated in the position shown in FIG. 1.

Welded or otherwise affixed at one end to the frusto-conical collar 14 and its other end to the clamp 36 is an adjustment bar 42 that has a plurality of longitudinally spaced apertures 44 extending through its thickness dimension.

Completing the assembly is an arcuate claw member 46 comprising a pair of curved steel straps 48 and 50 that are held in parallel, closely spaced-apart relation by a spacer member 52 that is welded between the two straps. A first end of the claw member 46 straddles and is pivotally joined to the adjustment bar 42 by a pivot bolt 54 that is made to pass through aligned apertures in the straps 49 and 50 and through a selected one of the apertures 44 in the adjustment bar 42.

The free end of the claw member 46 includes sharpened teeth 56 and a further set of teeth 58, 60 are welded to the straps 48 and 50 of the arcuate claw member 46 proximal of the teeth 56.

In use, an operator may grasp the proximal end portion of the pole 12 and wheel the log jack 10 to the location of a log or severed tree trunk to be elevated. Depending upon 20) the diameter of the log in question, the operator will adjust the pivot point of the claw member 46 by selecting a particular one of the apertures 44 for placement of the pivot bolt 54 that will allow the arcuate claw member to partially encircle the log when the pointed end 16 of the jack is driven into the ground adjacent the log. With the handle in a generally vertical orientation, the arcuate claw member 46 will swing open to partially encircle the log to be elevated. As the proximal end of the handle is then lowered, the teeth 18, 56 and 58 will bite into the log with the wheel and axel assembly acting as a lever fulcrum. Given the location of the fulcrum and the length of the handle, rather heavy logs can be lifted and held up as the stand 34 is brought in contact with the ground. Once a log has been severed from a tree's trunk, the log jack may be used to push or pull the captured log to a different location, taking advantage of the wheel and axel assembly 20.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A log jack for elevating logs off the ground to facilitating cutting by a chain saw, the log jack comprising:
a) an elongated handle having a proximal end and a distal end;
b) a metal collar affixed to the distal end of the handle, said metal collar terminating in a pointed spike and having a serrated rib radially projecting out from the metal collar;
c) an inverted Y-shaped bracket secured to the collar and oriented 180° from the serrated rib with arms of the Y-shaped bracket pointed away from the handle;
d) an axel extending between the arms of the Y-shaped bracket and having a pair of wheels journaled for rotation on the axel;
e) a stand member affixed to the handle and longitudinally displaced from the axel; and
f) an arcuate claw member pivotally joined at one end to an adjustment bar at a selected position there along, said adjustment bar being affixed to the metal collar and having a log engaging tooth extending at a free end of the claw member.

2. The log jack of claim 1 and further including at least one additional tooth projecting from the arcuate claw member.

3. The log jack of claim 2 wherein the adjustment bar is attached to both said collar and the stand member and includes a plurality of longitudinally spaced apertures, any one of which is adapted to receive a pivot member there through for coupling the arcuate claw member to the adjustment bar depending on a diameter of a log to be raised.

4. The log jack of claim 3 wherein the arcuate claw member comprises a pair of identical curved arms held in parallel space relation and that straddle said adjustment bar proximate a selected pivot location.

5. The log jack of claim 1 wherein the stand member comprises a T-shaped member affixed to a clamp that encircles the elongated handle.

6. The log jack of claim 1 and further including a support brace extending between the metal collar and the axel.
